(19) United States
(12) Patent Application Publication
(10) Pub. No.: US 2010/0245792 A1
(43) Pub. Date: Sep. 30, 2010

(54) Alignment Measurement Arrangement, Alignment Measurement Method, Device Manufacturing Method and Lithographic Apparatus

(75) Inventors: Franciscus Godefridus Casper BIJNEN, Valkenswaard (NL); Richard Johannes Franciscus VAN HAREN, Waalre (NL); Xiuhong WEI, Eindhoven (NL)

Correspondence Address: PILLSBURY WINTHROP SHAW PITTMAN, LLP, P.O. BOX 10500, MCLEAN, VA, 22102, US

(73) Assignee: ASML NETHERLANDS B.V., Veldhoven (NL)

(21) Appl. No.: 12/730,764

(22) Filed: Mar. 24, 2010

Related U.S. Application Data
(60) Provisional application No. 61/163,727, filed on Mar. 26, 2009.

(51) Int. Cl. G03B 27/42; H04N 7/18

(52) U.S. Cl. 355/53; 348/135; 348/E07.085

(57) ABSTRACT

An alignment measurement arrangement includes a source, an optical system and a detector. The source generates a radiation beam with a plurality of wavelength ranges. The optical system receives the radiation beam, produces an alignment beam, directs the alignment beam to a mark located on an object, receives alignment radiation back from the mark, and transmits the received radiation. The detector receives the alignment radiation and detects an image of the alignment mark and outputs a plurality of alignment signals, r, each associated with one of the wavelength ranges. A processor, in communication with the detector, receives the alignment signals, determines signal qualities of the alignment signals; determines aligned positions of the alignment signals, and calculates a position of the alignment mark based on the signal qualities, aligned positions, and a model relating the aligned position to the range of wavelengths and mark characteristics, including mark depth and mark asymmetry.

This application claims priority and benefit under 35 U.S.C. §119(e) to U.S. Provisional Patent Application No. 61/163,727, entitled “Alignment Measurement Arrangement, Alignment Measurement Method, Device Manufacturing Method and Lithographic Apparatus,” filed on Mar. 26, 2009. The contents of that application are incorporated herein in their entirety by reference.

### FIELD

The present invention relates to a lithographic apparatus and a method for manufacturing a device.

### BACKGROUND

A lithographic apparatus is a machine that applies a desired pattern onto a substrate, usually onto a target portion of the substrate. A lithographic apparatus can be used, for example, in the manufacture of integrated circuits (ICs). In that instance, a patterning device, which is alternatively referred to as a mask or a reticle, may be used to generate a circuit pattern to be formed on an individual layer of the IC. This pattern can be transferred onto a target portion (e.g., comprising part of, one, or several dies) on a substrate (e.g., a silicon wafer). Transfer of the pattern is typically via imaging onto a layer of radiation-sensitive material (resist) provided on the substrate. In general, a single substrate will contain a network of adjacent target portions that are successively patterned. Known lithographic apparatus include so-called steppers, in which each target portion is irradiated by exposing an entire pattern onto the target portion at one time, and so-called scanners, in which each target portion is irradiated by scanning the pattern through a radiation beam in a given direction (the “scanning”-direction) while synchronously scanning the substrate parallel or anti-parallel to this direction. It is also possible to transfer the pattern from the patterning device to the substrate by imprinting the pattern onto the substrate.

Lithographic apparatus are known to use multiple alignment arrangements. Reference is made to e.g., U.S. Pat. No. 7,414,722 B2. U.S. Pat. No. 7,414,722 B2 describes an alignment measurement arrangement having a broadband source, an optical system and a detector and an associated alignment measurement method. The broadband source is arranged to generate a radiation beam with a first and second range of wavelengths. The optical system is arranged to receive the generated radiation beam, produce an alignment beam, direct the alignment beam to a mark located on an object, to receive alignment radiation back from the mark, and to transmit the alignment radiation. The detector is arranged to receive the alignment radiation and to detect an image of the alignment mark located on the object. The detector furthermore produces a first and a second alignment signal, respectively, associated with said first and second range of wavelengths, respectively. The alignment measurement arrangement finally has a processor, which is connected to the detector. The processor is arranged to receive the first and second alignment signal, to determine a first and second signal quality respectively of the first and second alignment signal respectively by using a signal quality indicating parameter, and to calculate a position of the alignment mark based on the first and second signal quality.

In one embodiment in U.S. Pat. No. 7,414,722 B2, the further alignment signal can be established by selecting the alignment signal with a best signal quality. In another embodiment, the further alignment signal is established by assigning at least a first and second weighing factor, respectively, to said first and second alignment signal, respectively, based on the first and second signal quality, respectively, as determined, and calculating a weighted sum of said first and second alignment signal.

It may be a disadvantage of the known alignment measurement arrangement and the known method that its performance may still be compromised due to e.g., variations in mark depth and/or mark asymmetry between marks on different wafers and/or between different marks from a plurality of marks on a single wafer. The variations may however be so large that they substantially affect the determination of the position of the alignment mark, which may result in a substantial misalignment and thus e.g., to a substantial overlay error, which in turn may lead to a reduced performance of the manufactured device. Variations in mark depth and/or mark asymmetry may e.g., arise as a result of processing steps in manufacturing an integrated circuit on a substrate whereby various processes are applied in the integrated circuit, such as etching and polishing, while applying multiple layers onto the substrate between a first and a second application of a first and a second desired pattern using the lithographic apparatus.

### SUMMARY

It is desirable to provide an alignment arrangement and alignment method with an improved performance in view of the prior art. In particular, it is desirable to provide an alignment arrangement and alignment method with a reduced impact of variations from one mark to another. Moreover, the present invention provides an alignment assembly, a lithographic apparatus, a device manufacturing method, a computer program product, and a data carrier, associated with the improved alignment method.

A first aspect provides an alignment measurement method for use with a lithographic apparatus, comprising:
a) detecting an image of at least one alignment mark located on an object upon illumination with radiation having a plurality of wavelength ranges;
b) producing a plurality of alignment signals, each alignment signal being associated with the image as detected with a corresponding wavelength range of the plurality of wavelength ranges;
c) determining a plurality of signal qualities for respective alignment signals by using at least one signal quality indicating parameter;
d) determining a plurality of aligned positions from respective alignment signals by using at least one mark position indicating parameter;
e) determining a position (Pos) of said at least one alignment mark based at least on at least two of the plurality of signal qualities and at least two of the plurality of aligned positions,
   wherein said determining of the position of said at least one alignment mark comprises solving a set of equations comprising a plurality of first equations and a plurality of second equations,
   the first equations being associated with a first relationship between at least the signal quality (WQ), the wavelength range of the radiation and a mark depth (D) of the at least one alignment mark, and
   the second equations being associated with a second relationship between at least the aligned position (AP), the position (Pos) of said at least one alignment mark, the wavelength range of the radiation and the mark depth (D) of the at least one alignment mark.

A second aspect provides an alignment measurement arrangement comprising:
a source arranged to generate a radiation beam with a plurality of wavelength ranges;
an optical system arranged to receive said radiation beam as generated, to produce an alignment beam, to direct said alignment beam to at least one mark located on an object, to receive alignment radiation back from said at least one mark and to transmit said alignment radiation;
a detector arranged to receive said alignment radiation and to detect an image of said at least one alignment mark located on said object and to produce a plurality of alignment signals, each alignment signal associated with a corresponding wavelength range; and
a processor connected to said detector wherein said processor is arranged to perform at least the actions c)-e) as defined above.

A third aspect provides a lithographic apparatus arranged to transfer a pattern from a patterning device onto a substrate, the lithographic apparatus comprising:
an alignment measurement arrangement as defined above, wherein said processor is further arranged to establish a position signal based on the position of said at least one alignment mark as determined;
an actuator connected to said processor being arranged to:
   receive said position signal;
   calculate a position correction based on said position signal as received;
   establish a position correction signal.
a support structure arranged to support said substrate to be aligned, said support structure being connected to said actuator;
   wherein said actuator is arranged to move said support structure in response to said position correction signal as established.

A fourth aspect provides a device manufacturing method comprising transferring a pattern from a patterning device onto a substrate using the lithographic apparatus as defined above.

A fifth aspect provides a computer program product comprising data and instructions to be loaded by a processor of a lithographic apparatus, and arranged to allow said lithographic apparatus to perform the alignment measurement method as defined above.

A sixth aspect provides a data carrier comprising a computer program product as defined above.

### BRIEF DESCRIPTION OF THE DRAWINGS

Embodiments of the invention will now be described, by way of example only, with reference to the accompanying schematic drawings in which corresponding reference symbols indicate corresponding parts, and in which:

FIG. 1 depicts a lithographic apparatus according to an embodiment of the invention;

FIG. 2 shows a schematic example of a field image alignment arrangement;

FIGS. 3a and 3b shows an example of a mark that can be used in the alignment arrangement of FIG. 2;

FIG. 4 shows an output signal of a detector used in the arrangement of FIG. 2 and receiving alignment radiation back from a mark;

FIGS. 5 and 6 show further examples of marks that can be used in the arrangement of FIG. 2;

FIG. 7a shows a flow chart of an alignment measurement method in accordance with a known method;

FIG. 7b shows a flow chart of an alignment measurement method in accordance with an embodiment of the invention;

FIG. 8 schematically shows a field image alignment arrangement according to an embodiment of the invention;

FIGS. 9a and 9b schematically show two examples of filter units that can be used in the alignment arrangement of FIG. 8;

FIG. 10 shows a graph that provides information regarding the spectral sensitivity of a multicolor CCD-camera;

FIGS. 11a and 11b show two examples of spatial filters that can be employed in a CCD-camera;

FIG. 11c shows an embodiment of a detector suitable for use with the present invention;

FIGS. 12a, 12b and 12c show aspects of examples light sources and wavelength ranges that can be used in the alignment arrangement according to the invention;

FIG. 13 shows a computer comprising a processor as used in embodiments of the invention;

FIG. 14 shows a flow chart of an alignment measurement method according to another embodiment of the invention;

FIG. 15 shows a flow chart of an alignment measurement method according to again another embodiment of the invention.

### DETAILED DESCRIPTION

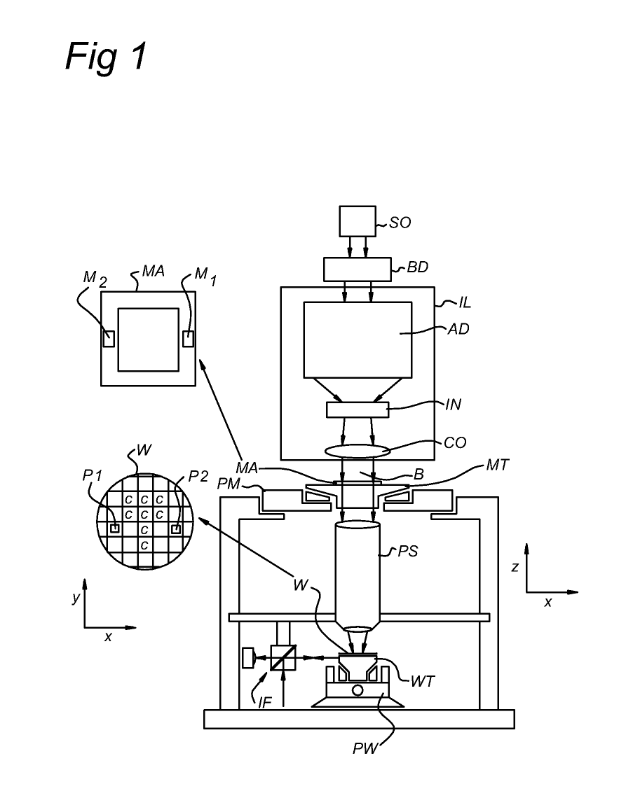

FIG. 1 schematically depicts a lithographic apparatus according to one embodiment of the invention. The apparatus comprises:

an illumination system (illuminator) IL configured to condition a radiation beam B (e.g., UV radiation or EUV-radiation).

a support structure (e.g., a mask table) MT constructed to support a patterning device (e.g., a mask) MA and connected to a first positioner PM configured to accurately position the patterning device in accordance with certain parameters;

a substrate table (e.g., a wafer table) WT constructed to hold a substrate (e.g., a resist-coated wafer) W and connected to a second positioner PW configured to accurately position the substrate in accordance with certain parameters; and

a projection system (e.g., a refractive projection lens system) PS configured to project a pattern imparted to the radiation beam B by patterning device MA onto a target portion C (e.g., comprising one or more dies) of the substrate W.

The illumination system may include various types of optical components, such as refractive, reflective, magnetic, electromagnetic, electrostatic or other types of optical components, or any combination thereof, for directing, shaping, or controlling radiation.

The support structure supports, i.e., bears the weight of, the patterning device. It holds the patterning device in a manner that depends on the orientation of the patterning device, the design of the lithographic apparatus, and other conditions, such as for example whether or not the patterning device is held in a vacuum environment. The support structure can use mechanical, vacuum, electrostatic or other clamping techniques to hold the patterning device. The support structure may be a frame or a table, for example, which may be fixed or movable as required. The support structure may ensure that the patterning device is at a desired position, for example with respect to the projection system. Any use of the terms “reticle” or “mask” herein may be considered synonymous with the more general term “patterning device.”

The term “patterning device” used herein should be broadly interpreted as referring to any device that can be used to impart a radiation beam with a pattern in its cross-section such as to create a pattern in a target portion of the substrate. It should be noted that the pattern imparted to the radiation beam may not exactly correspond to the desired pattern in the target portion of the substrate, for example if the pattern includes phase-shifting features or so called assist features. Generally, the pattern imparted to the radiation beam will correspond to a particular functional layer in a device being created in the target portion, such as an integrated circuit.

The patterning device may be transmissive or reflective. Examples of patterning devices include masks, programmable mirror arrays, and programmable LCD panels. Masks are well known in lithography, and include mask types such as binary, alternating phase-shift, and attenuated phase-shift, as well as various hybrid mask types. An example of a programmable mirror array employs a matrix arrangement of small mirrors, each of which can be individually tilted so as to reflect an incoming radiation beam in different directions. The tilted mirrors impart a pattern in a radiation beam which is reflected by the mirror matrix.

The term “projection system” used herein should be broadly interpreted as encompassing any type of projection system, including refractive, reflective, catadioptric, magnetic, electromagnetic and electrostatic optical systems, or any combination thereof, as appropriate for the exposure radiation being used, or for other factors such as the use of an immersion liquid or the use of a vacuum. Any use of the term “projection lens” herein may be considered as synonymous with the more general term “projection system”.

As here depicted, the apparatus is of a transmissive type (e.g., employing a transmissive mask). Alternatively, the apparatus may be of a reflective type (e.g., employing a programmable mirror array of a type as referred to above, or employing a reflective mask).

The lithographic apparatus may be of a type having two (dual stage) or more substrate tables (and/or two or more mask tables). In such “multiple stage” machines the additional tables may be used in parallel, or preparatory steps may be carried out on one or more tables while one or more other tables are being used for exposure.

The lithographic apparatus may also be of a type wherein at least a portion of the substrate may be covered by a liquid having a relatively high refractive index, e.g., water, so as to fill a space between the projection system and the substrate. An immersion liquid may also be applied to other spaces in the lithographic apparatus, for example, between the mask and the projection system. Immersion techniques are well known in the art for increasing the numerical aperture of projection systems. The term “immersion” as used herein does not mean that a structure, such as a substrate, must be submerged in liquid, but rather only means that liquid is located between the projection system and the substrate during exposure.

Referring to FIG. 1, the illuminator IL receives a radiation beam from a radiation source SO. The source and the lithographic apparatus may be separate entities, for example when the source is an excimer laser. In such cases, the source is not considered to form part of the lithographic apparatus and the radiation beam is passed from the source SO to the illuminator IL with the aid of a beam delivery system BD comprising, for example, suitable directing mirrors and/or a beam expander. In other cases the source may be an integral part of the lithographic apparatus, for example when the source is a mercury lamp. The source SO and the illuminator IL, together with the beam delivery system BD if required, may be referred to as a radiation system.

The illuminator IL may comprise an adjuster AD for adjusting the angular intensity distribution of the radiation beam. Generally, at least the outer and/or inner radial extent (commonly referred to as σ-outer and σ-inner, respectively) of the intensity distribution in a pupil plane of the illuminator can be adjusted. In addition, the illuminator IL may comprise various other components, such as an integrator IN and a condenser CO. The illuminator may be used to condition the radiation beam, to have a desired uniformity and intensity distribution in its cross-section.

The radiation beam B is incident on the patterning device (e.g., mask MA), which is held on the support structure (e.g., mask table MT), and is patterned by the patterning device. Having traversed the mask MA, the radiation beam B passes through the projection system PS, which focuses the beam onto a target portion C of the substrate W. With the aid of the second positioner PW and position sensor IF (e.g., an interferometric device, linear encoder or capacitive sensor), the substrate table WT can be moved accurately, e.g., so as to position different target portions C in the path of the radiation beam B. Similarly, the first positioner PM and another position sensor (which is not explicitly depicted in FIG. 1) can be used to accurately position the mask MA with respect to the path of the radiation beam B, e.g., after mechanical retrieval from a mask library, or during a scan. In general, movement of the mask table MT may be realized with the aid of a long-stroke module (coarse positioning) and a short-stroke module (fine positioning), which form part of the first positioner PM. Similarly, movement of the substrate table WT may be realized using a long-stroke module and a short-stroke module, which form part of the second positioner PW. In the case of a stepper (as opposed to a scanner) the mask table MT may be connected to a short-stroke actuator only, or may be fixed. Mask MA and substrate W may be aligned using mask alignment marks M1, M2 and substrate alignment marks P1, P2. Although the substrate alignment marks as illustrated occupy dedicated target portions, they may be located in spaces between target portions (these are known as scribe-lane alignment marks). Similarly, in situations in which more than one die is provided on the mask MA, the mask alignment marks may be located between the dies.

The depicted apparatus could be used in at least one of the following modes:

1. In step mode, the mask table MT and the substrate table WT are kept essentially stationary, while an entire pattern imparted to the radiation beam is projected onto a target portion C at one time (i.e., a single static exposure). The substrate table WT is then shifted in the X and/or Y direction so that a different target portion C can be exposed. In step mode, the maximum size of the exposure field limits the size of the target portion C imaged in a single static exposure.

2. In scan mode, the mask table MT and the substrate table WT are scanned synchronously while a pattern imparted to the radiation beam is projected onto a target portion C (i.e., a single dynamic exposure). The velocity and direction of the substrate table WT relative to the mask table MT may be determined by the (de-)magnification and image reversal characteristics of the projection system PS. In scan mode, the maximum size of the exposure field limits the width (in the non-scanning direction) of the target portion in a single dynamic exposure, whereas the length of the scanning motion determines the height (in the scanning direction) of the target portion.

3. In another mode, the mask table MT is kept essentially stationary holding a programmable patterning device, and the substrate table WT is moved or scanned while a pattern imparted to the radiation beam is projected onto a target portion C. In this mode, generally a pulsed radiation source is employed and the programmable patterning device is updated as required after each movement of the substrate table WT or in between successive radiation pulses during a scan. This mode of operation can be readily applied to maskless lithography that utilizes programmable patterning device, such as a programmable mirror array of a type as referred to above.

Combinations and/or variations on the above described modes of use or entirely different modes of use may also be employed.

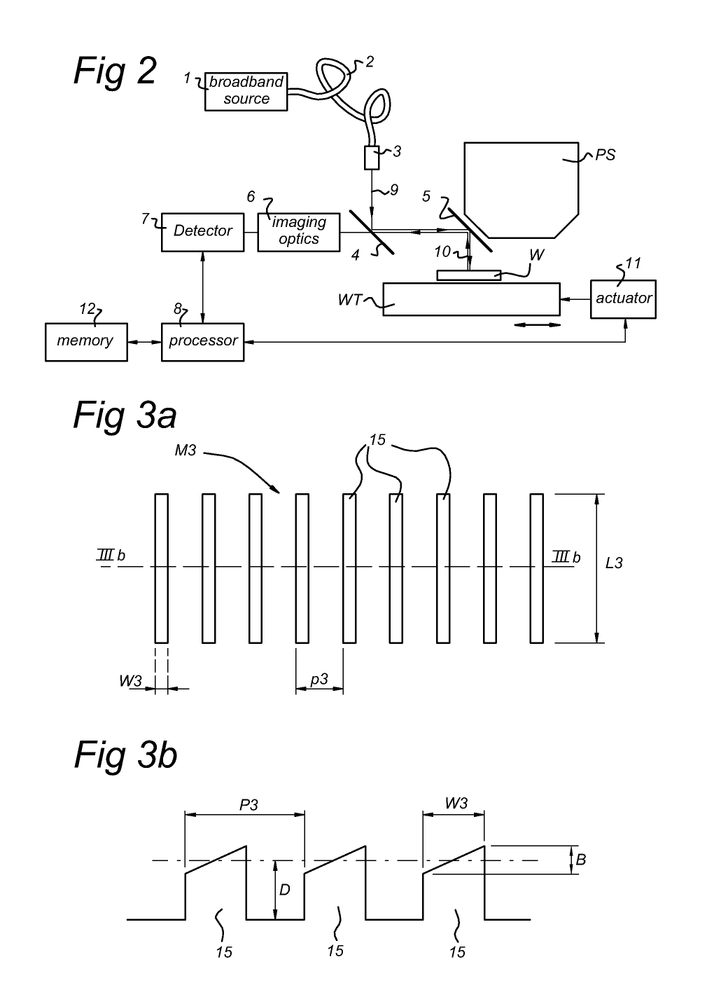

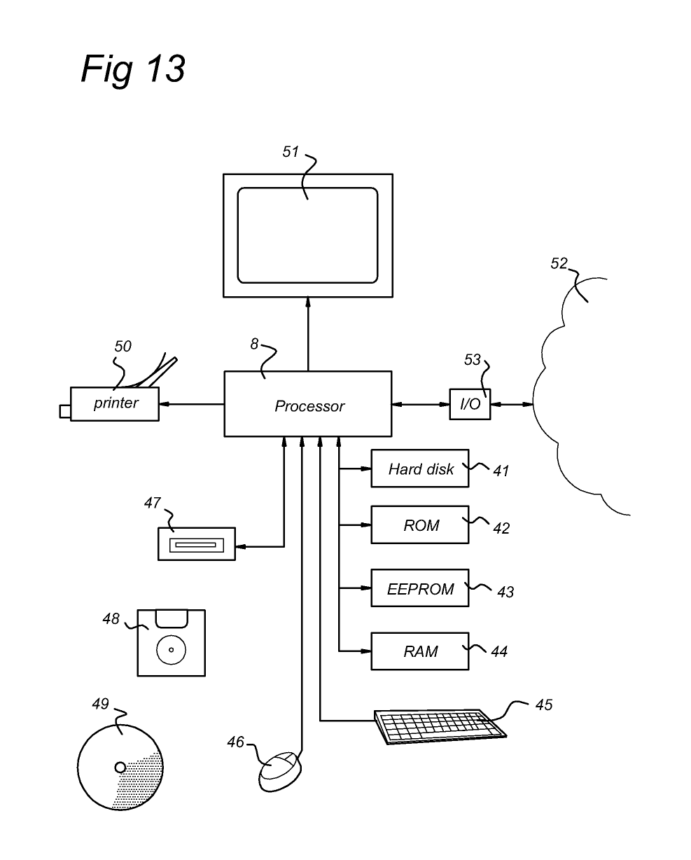

FIG. 2 shows a schematic example of a field image alignment arrangement. Such an alignment arrangement is based on a static measurement. The field image alignment arrangement of FIG. 2 comprises a light source 1, which is a broadband source. The light source 1 is connected to one end of a fiber 2. A transmitter 3 is connected to the opposite end of the fiber 2. Optics to provide an alignment beam towards a mark M3 (cf. FIG. 3a) on substrate W include a semi-transparent mirror 4 and a mirror 5. Imaging optics 6 are provided to receive alignment radiation back from the mark M3 and to provide a suitable optical image to a detector 7, e.g., a charged coupled device (CCD). The detector 7 is connected to a processor 8. The processor 8 in its turn is connected to an actuator 11 and a memory 12. The actuator 11 is connected to the substrate table WT, on which substrate W can be placed. In FIG. 2, both the processor 8 and the memory 12 are presented as separate units. The processor 8 and/or the memory 12 may however be physically located within the detector 7. Furthermore, either one of them may be part of a computer assembly as described with reference to FIG. 13.

In use, the light source 1 produces a broadband light beam that is output via the fiber 2 to the transmitter 3. The transmitter 3 provides a broadband light beam 9 that is reflected by mirror 4 to mirror 5. Mirror 5 produces a broadband alignment beam 10 to be directed to mark M3 on substrate W. The broadband light beam 10 impinging on the mark M3 is reflected back as alignment radiation to the mirror 5. The mirror 5 reflects the received light to the semi-transparent mirror 4 which passes at least a portion of the received light to the imaging optics 6. The imaging optics 6 is arranged to collect the received alignment radiation and to provide a suitable optical image to the detector 7. The detector 7 provides an output signal to the processor 8 that depends on the content of the optical image received from the imaging optics 6. The output signal that is received from the detector 7 as well as results of actions performed by the processor 8 may be stored in the memory 12. The processor 8 calculates a position of the alignment mark M3 based on one or more of the output signal it receives from the detector 7. It then provides a further output signal to the actuator 11. The actuator 11 is arranged to move substrate table WT. Upon reception of the further output signal the actuator 11 moves the substrate table WT towards a desired position.

FIG. 3a shows a top view of a mark M3 present on substrate W that can be used in the present invention. It comprises a plurality of bar-shaped structures 15 that have a width W3 and a length L3. Typical values for these dimensions are: W3=6 μm, L3=75 μm. The bar-shaped structures 15 have a pitch P3. A typical value for the pitch P3=12 μm.

FIG. 3b shows an example of a cross section of the mark M3 along line Mb of FIG. 3a. The mark M3 has a mark depth D. The mark depth D may be different during the subsequent processing of the substrate W, e.g., due to the application and patterning of multiple layers of a plurality of materials during the manufacturing of an integrated surface, which may e.g., involved polishing steps. Although the mark M3 is designed as having substantially symmetric bar-shaped structures 15, the bar-shaped structures 15 of mark M3 shown in FIG. 3b are asymmetric. This asymmetry may e.g., be expressed as a difference in heights of both sides of the bar-shaped structures 15, as indicated with B in FIG. 3b. This so-called mark asymmetry may originate from e.g., the application and patterning of multiple layers.

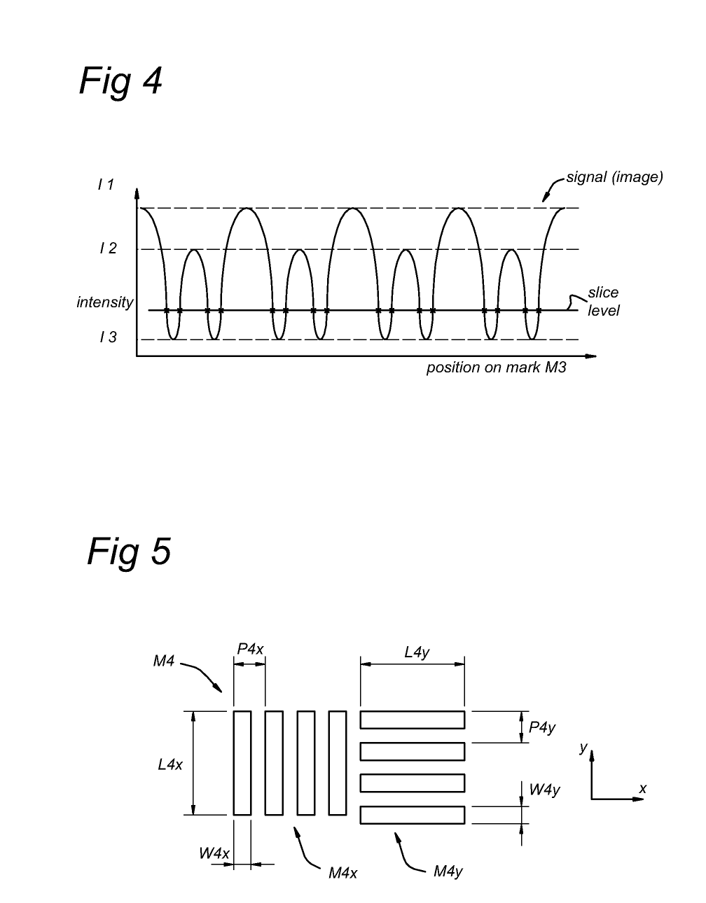

FIG. 4 shows an output signal of the detector 7 that is transmitted to the processor 8 based on the optical image of the mark M3, as received from the imaging optics 6. Note that the output signal can take the form of a two-dimensional image that is transferred to the processor 8. The curve shown in FIG. 4 shows intensity of the signal as a function of position of the mark M3 while being illuminated with the broadband alignment beam 10. The curve shows absolute maxima at an intensity level of I1, local maxima with an intensity level of I2 and absolute minima with an intensity level of I3. The absolute maxima I1 are associated with the centers of the respective bar-shaped structures 15. The local maxima 12 are associated with the centers of the spaces between adjacent bar-shaped structures 15. The absolute minima 13 are associated with locations just beside transitions of the bar-shaped structures 15 towards the intermediate spaces between the bar-shaped structures 15. So, the slopes of the curve between absolute maxima I1 and local maxima 12 are due to transitions between the bar-shaped structures 15. At these transitions, i.e., side faces of the bar-shaped structures 15, only little light is reflected.

Thus the detector 7 receives a 2-D image of the mark M3. The output signal of the detector 7 to the processor 8 may only comprise 1-D information. It is however possible to transfer the 2-D image to the processor 8, and determine the position based on this image using a certain algorithm. Various algorithms can be used to arrive at an intensity signal as shown in FIG. 4 from the received image information. For example, the detector may be a CCD-camera comprising camera pixels arranged in a matrix forming a detecting surface. E.g., the detector 7 may be a CCD with CCD-elements arranged in columns and rows, where the signals received by the CCD-elements in a column are averaged. For further details, the reader is referred to the article by K. Ota et al., New Alignment Sensors for Wafer Stepper, SPIE, Vol. 1463, Optical/Laser Microlithography IV (1991), p. 304-314. An another example, the detector may be arranged to match the image of the mark with a reference pattern provided as a reference structure with the detector. The reference structure may e.g., be a reference grating, matching the image of mark M3 comprising the plurality of bar-shaped structures 15 (as shown in FIG. 3a). For further examples and further details, the reader is referred to EP 0 906 590 describing an off-axis alignment unit, and to EP 1 372 040 A2 describing a self-referencing interferometer.

Furthermore, various algorithms can be used to arrive at an alignment position based on the intensity signal shown in FIG. 4. One algorithm uses a slice level as shown in FIG. 4. An intensity value in between I1 and I3 is selected, based on this selected value (slice level) a location of mark M3 is determined.

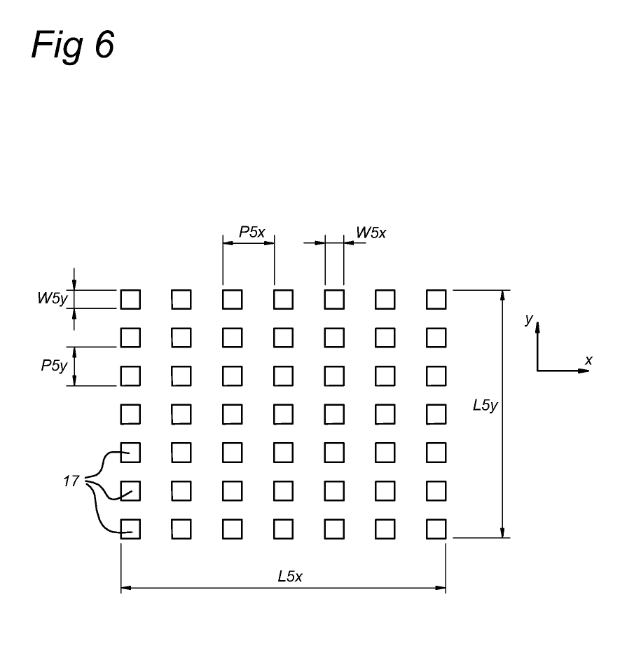

FIGS. 5 and 6 show alternative marks M4 and M5 respectively that can be used in the present invention. The alignment mark M4 as shown in FIG. 5 has a mark portion M4x for measuring a position in an x-direction and a mark portion M4y for measuring a position in a y-direction. The mark portion M4x is similar to the mark M3. It comprises a plurality of bar-shaped structures with a width W4x, a length L4x, and a pitch P4x. The mark portion M4y is similar to the mark portion M4x, but rotated by 90°. The mark portion M4y comprises bar-shaped structures with a width W4y, a length L4y, and a pitch P4y. The widths W4x, W4y, the lengths L4x, L4y, and the pitches P4x, P4y, respectively, have similar values as the width W3, the length L3, and the pitch P3 respectively of mark M3. When one wishes to measure a position in one direction only it is sufficient to provide only mark portion M4x or mark portion M4y. When such an alignment mark M4 is provided on the substrate table WT, the alignment mark M4 can also be used for on-line calibration purposes.

FIG. 6 shows another example of an alignment mark M5 that can be used in the present invention. The alignment mark has a plurality of columns. In each column a plurality of square shaped structures 17 is located. The square shaped structures 17 have a width W5x in the x-direction and a width W5y in the y-direction. The length of the mark M5 in the x-direction is L5x and the length of the mark M5 in the y-direction is LSy. The mark M5 has a pitch P5x between adjacent columns in the x-direction and a pitch P5y between the rows in the y-direction. Typical values of the widths W5x, W5y are 4 μm. Typical values for the lengths L5x, L5y are 40-100 μm. Typical values for pitches P5x, P5y are 8 μm. When used in the alignment arrangement of FIG. 2, an intensity signal similar to the one shown in FIG. 4 will be produced by detector 7 for processor 8. The mark M5 could be less optimal than the mark M3 or M4 due to a poorer signal/noise ratio. However, due to the use of a broadband light source 1, this is anticipated to be a minor problem, since the use of a broadband light source 1 results in constructive interference at some portion of the used bandwidth. Moreover, note that the alignment mark M5 can, in principle, also be used in both the x-direction and the y-direction.

In semiconductor processes, alignment marks are altered in various ways. Among others, the contrast due to interference may be deteriorated as a result of these mark alterations, an effect that may lead to alignment errors. The decrease of contrast depends on the wavelength of the illumination light. In case height variations within a mark correspond to a phase depth of λ/2, destructive interference will be present, i.e., the mark acts as a flat mirror. In this case no contrast will be detected, since all light will be diffracted in the zero-th order. Furthermore, light will be diffracted into higher orders for phase depths unequal to λ/2.

In a field image alignment arrangement, generally a broadband illumination source is used, as shown in FIG. 2. Although some wavelengths will destructively interfere, other wavelengths within the range of wavelengths generated by the broadband illumination source will constructively interfere. Therefore, there will always be constructive interference, i.e., there is always contrast in an alignment signal established by the detector upon detection of an image of the alignment mark, which is illuminated with broadband radiation. Alignment systems employing field image alignment utilize a fixed illumination bandwidth, generally between 530 and 650 nm, detect a fixed amount of diffraction orders and integrate all wavelengths on a single detector, that provides an image of the alignment mark. The accuracy of such an alignment system is limited. Especially, the accuracy may be hampered by a variation of mark characteristics from one mark to another, such as mark-depth variations and/or mark-asymmetry variations.

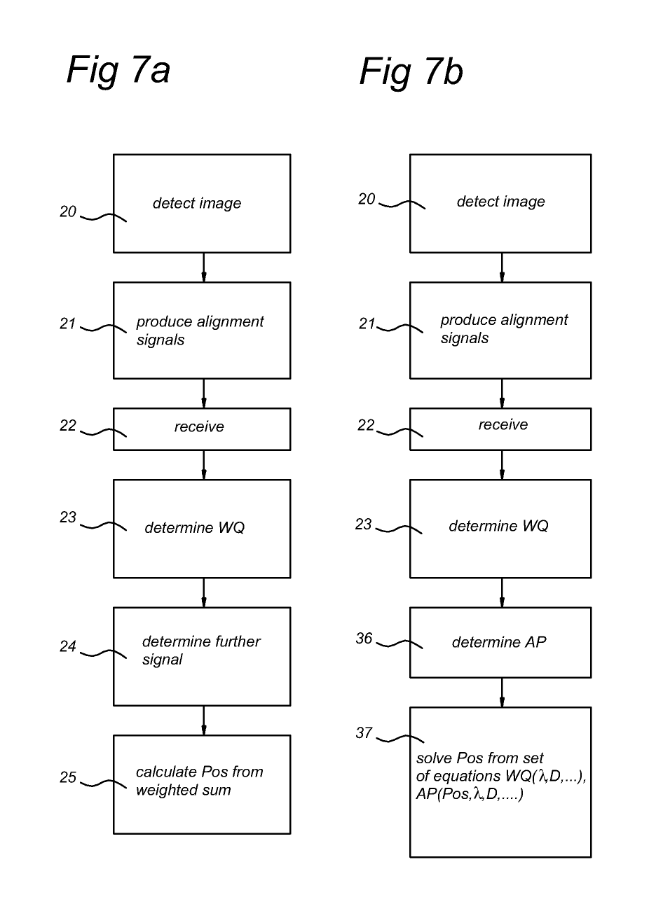

FIG. 7a shows a flow chart of an alignment measurement method in accordance with the known method described in U.S. Pat. No. 7,414,722 B2. FIG. 7b shows a flow chart of an alignment measurement method in accordance with an embodiment of the present invention. These alignment methods can be performed with the field image alignment arrangement shown in FIG. 2. In all three flow charts, the detector 7 first detects in action 20 an image of an alignment mark that has been illuminated with radiation having a plurality of predetermined ranges of wavelengths, e.g., alignment beam 10. Upon detection, the detector 7 produces in action 21 a selection of alignment signals, i.e., each alignment signal relates to a detected image of the at least one alignment mark that is formed by a different predetermined range of wavelengths. The selection of alignment signals can be obtained by consecutively illuminating the at least one alignment mark with a different predetermined selected range of wavelengths, for example by consecutively applying different types of filters to filter the broadband light beam 9 generated by the broadband source 1, each filter being designed to pass only a predetermined range of wavelengths. Examples of filter units comprising a number of filters are schematically shown in FIGS. 9a, 9b. In another embodiment, the images for different predetermined ranges of wavelengths are obtained by providing a detector 7 that can measure aforementioned ranges in parallel as will be explained later. The alignment signals produced by the detector 7 are received by processor 8 in action 22. Then, the signal quality of all produced alignment signals is determined in action 23 by using one or more quality indicating parameters. The signal quality may also be referred to as wafer quality WQ, as, when the alignment mark is a mark on the wafer, it is indicative for the quality of detecting the alignment mark on the wafer with the current range of wavelengths. We will use the acronym WQ in formulas and for easy reference in the following. Examples of such quality indicating parameters include signal strength, noise level and fit quality of the alignment signal. The signal quality of the alignment signals can automatically be determined by processor 8, as will be evident to persons skilled in the art.

In the method described in U.S. Pat. No. 7,414,722 B2, shown in FIG. 7a, the determined signal quality for each alignment signal is then used to establish in action 24 a further alignment signal. In an embodiment of the method of U.S. Pat. No. 7,414,722 B2, the further alignment signal is identical to the alignment signal with the best determined signal quality. In another embodiment of the method of U.S. Pat. No. 7,414,722 B2, a weighing factor is assigned to each alignment signal, wherein the value of the weighing factor is based on the determined signal quality per alignment signal. The further alignment signal then corresponds to a weighted sum of all alignment signals. Finally, a position of the at least one alignment mark is calculated in action 25, based on the established further alignment signal. In case of a measurement on more than one mark, i.e., a multiple mark measurement, the actions 24 and 25 can be performed per mark resulting in a different weighted sum for each alignment mark. Actions 24 and 25 can also be performed automatically by processor 8, as will be evident to persons skilled in the art.

An embodiment of the method according to the present invention is shown in FIG. 7b. After action 23, the method continues to action 36. A position estimate of the alignment mark is determined for each alignment signal in action 36. The position estimate will be further referred to as the aligned position AP. The aligned position AP may also be referred to as the apparent position, to indicate explicitly that it is the position where the mark appears to be using the wavelength range, which may differ from the (actual) position of the alignment mark on the object. In case of a measurement on more than one mark, action 36 is performed per mark. The aligned position corresponds to the position where the associated alignment signal has an optimal signal quality. Consecutively, based on both the calculated position estimate AP and the determined signal quality WQ for each established alignment signal, processor 8 determines a position of the alignment mark in action 37. To this end, processor 8 solves a set of equations comprising a plurality of first equations and a plurality of second equations, the first equations being associated with a first relationship between at least the signal quality WQ, the wavelength range of the radiation and a mark depth D of the alignment mark, and the second equations being associated with a second relationship between at least the aligned position AP, the position Pos of said at least one alignment mark, the wavelength range of the radiation and the mark depth D of the alignment mark.

The signal quality WQ is thus not used to just select or weigh the alignment signals (as in the known method of U.S. Pat. No. 7,414,722 B2, described above with reference to FIG. 7a), but instead an information content of the signal quality WQ is used, associated with the modelled relationship between the signal quality WQ, the range of wavelengths used and mark characteristics, including the mark depth D. The modeled relationship of the aligned position may include also e.g., a mark asymmetry. This approach may allow an improvemend in performance in determining the true position of the alignment mark. Effects due to mark-depth variation and mark-asymmetry variation between different marks of a plurality of alignment marks may be accounted for by using the model with, for each range of wavelengths, a plurality of signal qualities, where each signal quality corresponds to one of the plurality of alignment marks.

In an embodiment, detecting the image is performed substantially simultaneously for all plurality of wavelength ranges upon simultaneous illumination with the plurality of wavelength ranges.

In another embodiment, detecting the image is performed sequentially for the plurality of wavelength ranges upon sequential illumination with each of the wavelength ranges of the plurality of wavelength ranges.

Embodiments of the model are now illustrated with several examples. As each range of wavelengths may, in a selected model, be parameterized by one wavelength, a wavelength range is referred to as a wavelength in the examples below.

### Example 1

### Determining the Position of a Single Alignment Mark

A first example allows to be independent of mark depth variation (D) by measuring the Wafer Quality (WQ) and the Aligned Position (AP) at two, or more, wavelengths (λ1, λ2, . . . ) close to each other, e.g., separated by a few nm, on a single alignment mark.

Alignment gives us the following data:

WQ(λ1), WQ(λ2), . . . and

AP(λ1), AP(λ2), . . .

A suitable (to first order) relationship between WQ, mark depth, phase and wavelength is given by:

WQ(λ)=A(λ)·sin²(2πD/λ+φ) eq (a)

and a suitable (first order) relationship between Aligned Position, the “true” alignment mark position (Pos), mark depth (D), phase and wavelength is given by:

AP(λ)=Pos+B(λ)·tan(2πD/λ+½*π+φ) eq (b)

where:
D is the depth of the mark;
A(λ) is typically a slowly varying factor as function of the wavelength, and may e.g., comprise wavelength dependent absorption;
B(λ) is a factor which depends on the asymmetry of the mark, with B(λ) being 0 when there is no asymmetry; typical values for B(λ) can be 0-10 nm; and φ is the local phase (for etched wafers φ=0).

For explanation of the idea we first take the simple case of two wavelengths and take φ=0. In case of two wavelengths we will get the following set of equations for a certain mark:

a first plurality of equations associated with the relationship between wafer quality WQ, mark depth, phase and wavelength:

WQ(λ₁)=A(λ₁)·sin²(2πD/λ₁)

WQ(λ₂)=A(λ₂)·sin²(2πD/λ₂) eq (1-2)

a second plurality of equations associated with the aligned position AP, the “true” alignment mark position (Pos), mark depth (D), phase and wavelength:

AP(λ₁)=Pos+B(λ₁)·tan(2πD/λ₁+½*π)

AP(λ₂)=Pos+B(λ₂)·tan(2πD/λ₂+½*π) eq (3-4)

Since the wavelengths are close to each other the following approximation can be made for equations 1 and 2:

A(λ₁)=A(λ₂)

Now the equation (1-2) can transferred into equation 5:

WQ(λ₁)/WQ(λ₂)=sin²(2πD/λ₁)/sin²(2πD/λ₂) eq (5)

which can be solved to yield the (effective) mark depth D.

The (numerically or analytically) found solution for D can then be inserted into equations 3 and 4. Also here we can assume that the asymmetry factor B(λ) is a slowly varying function of λ, and make the approximation:

B(λ₁)=B(λ₂)

Then by entering the solution for D, obtained from equation 5, in eqs 3-4, the set of equations is solved to find the position Pos of the mark.

A three-wavelength detection system would be used if phase modeling were to be included. As a matter of practical application, it may be necessary to take this approach.

In that case the set of equations to be solved to determine the position Pos of the alignment mark would be:

WQ(λ₁)=A(λ₁)·sin²(2πD/λ₁+φ)

WQ(λ₂)=A(λ₂)·sin²(2πD/λ₂+φ)

WQ(λ₃)=A(λ₃)·sin²(2πD/λ₃+φ) eq (c)

AP(λ₁=Pos+B(λ₁)·tan(2πD/λ₁+½+φ)

AP(λ₂=Pos+B(λ₂)·tan(2πD/λ₂+½+φ)

AP(λ₃=Pos+B(λ₃)·tan(2πD/λ₃+½+φ)

Again assuming A and B to be independent of λ, we now have 5 parameters with 6 equations. This can be solved in various ways, e.g., as:

this set of equations can be solved as an over-determined system and may then e.g., also provide a measure on any residuals (which may be used to select for an optimum colour combination);

solve the 5 equations as a fully determined system, allowing to check the assumptions that A is constant and/or that B is constant; or

solve the 6 equations as a fully determined system while adding another parameter. E.g., the factor depending on the asymmetry of the mark could be parameterized as B(λ)=B₀+Bc*λ, wherein B0 and Bc are wavelength-independent parameters. In that case B0 and Bc need to be solved.

The (three-wavelength) detection (including phase determination) allows to calculate the position based on the local approximation by these equations.

Note also that the choice for the functional shape of equations a, b, c and d shown above is based on a first order model. Another suitable function like e.g., a Taylor expansion around an expected depth D may alternatively used.

### Example 2

### Determining the Position of a Plurality of Alignment Marks on a Single Wafer

According to an embodiment, the method further allows a measurement to be independent of mark depth variation between different marks on a single wafer. The mark depth may be expressed as a function of position on the wafer as D(x,y).

The Wafer Quality (WQ) and the Aligned Position (AP) may be measured on a plurality of marks on a wafer using again at least two, or more, wavelengths (λ). The wavelengths are allowed to be separated substantially.

A model is used, comprising a set of equations incorporating the alignment results, which equations can be coupled and solved by assuming a set of relations to be (locally) true.

From the alignment signals, the following data is established:

WQ₁(λ₁), WQ₁(λₖ), . . . WQ₁(λₖ₀)

AP₁(λ₁), AP₁(λₖ), . . . AP₁(λₖ₀)

. . .

WQₙ(λ₁), . . . WQₙ(λₖ) . . . WQₙ(λₖ₀)

APₙ(λ₁) . . . APₙ(λₖ) . . . APₙ(λₖ₀)

. . .

WQₙ₀(λ₁) . . . WQₙ₀(λₖ), . . . WQₙ₀(λₖ₀)

APₙ₀(λ₁) . . . APₙ₀(λₖ), . . . APₙ₀(λₖ₀)

with
WQₙ(λₖ) the wafer quality of mark n at wavelength λₖ;
APₙ(λₖ) the Aligned Position of mark n at wavelength λₖ;
n₀ indicates the number of alignment marks;
k₀ indicates the number of wavelengths used;
These measured data can be coupled introducing equations containing additional parameters which hold for simple (and local) situations.

A suitable (to first order) relationship between wafer quality WQₙ(λₖ), mark depth D_{n,k}, phase φₙ(λₖ) and wavelength λₖ is given by:

WQₙ(λₖ)=Aₙ(λₖ)·sin²(2πD_{n,k}/λₖ+φₙ(λₖ)) eq (aa)

A suitable (first order) relationship between Aligned Position APₙ(λₖ), the “true” alignment mark position Posₙ, mark depth D_{n,k} and wavelength λₖ is given by:

APₙ(λₖ)=Posₙ+Bₙ(λₖ)·tan(2πD_{n,k}/λₖ+½*π+φₙ(λₖ)) eq (bb)

where
D_{n,k} is the effective depth of the mark n at wavelength λₖ;
Aₙ(λₖ) is typically a slowly varying factor as function of the wavelength. Wavelength dependent absorption and mark dependent absorbing layer thickness variation are part of this factor;
Bₙ(λₖ) is a factor which depends on the asymmetry of the mark; B(λ) is 0 when there is no asymmetry; typical values for Bₙ(λₖ) are 0-10 nm;
φₙ(λₖ) is the local phase; for an etched wafers φ=0;
Posₕ is the “true” alignment mark position of alignment mark n (i.e., the position of the alignment mark independent of the wavelength used).

Next, a solution needs to be found to this system of equations, which is underdetermined:

the system has a number of equations equal to:

k0*n0(WQ)+k0*n0(AP)=2*k0*n0 equations,

and a number of unknowns (variables) equal to:

n0(Pos)+n0*k0(A)+n0*k0(B)++n0*k0(D)+n0*k0(φ)=(4*k0+1)*n0 variables.

The solution to this underdetermined set of equations can be found by making sensible approximations which allow reduction of the number of variables. To come to a solution to the equations (aa) and (bb) above, the origin of the optical signals should be equal since a correlation should exist between the results of at least two colors. This means that the signal should come from the same layer. Note that this is not always the case: If one colour can probe through the layer stack until the mark as printed (e.g., FIR) and another colour (e.g., green) can only probe topology changes at the top surface of the wafer, because the layer is opaque for the color, one can expect that the signals of the colors will not correlate enough. The colours may thus be chosen dependent on the stage of the IC manufacturing process, in particular dependent on the type (materials) and thickness of the layers. Correlation of a number of colours will be the case for a limited amount of wavelengths, which will be selected as a set of fulfilling wavelengths {kᵣ}, with number of fulfilling wavelengths kᵣ₀=k0.

Note that this assumption decreases both the number input equations as the number of variables and is therefore a requisite for the colours to be useful in this approach.

When colours correlate, for each variable some assumptions can be made as given below:

For colours which align to the same (buried) mark structure and hence correlate, the effective mark depth D is independent of the wavelength;

Since processing is a local phenomenon D is further dependent on the position of the mark on the wafer. Dₙ can therefore be approximated by a M-th order model. A choice for m may e.g., be m=10. An optimal value for m may be determined e.g., in dependence of the used processing equipment. Thus:

D_{n,k}=D(x,y,k)=d₁(k)+d₂*x+d₃*y+ . . . dₘ*fₘ(x,y) for wavelengths kε{kᵣ}

For the signal amplitude (A), the asymmetry variable (B) and the phase (φ), a similar arguing holds as for the parameterization of the effective mark depth (D).

A Q-th order model can be fit to the data describing A,

a S-th order model can be fit to the data describing B and

a F-th order model to describe φ.

An exemplary choice for Q, S and F may be 10.

It is assumed that the signal amplitude A, asymmetry parameter B and phase φ can be approximated by the following equations:

A_{n,k}=A_{{kr}}(x,y,k)=a₁(k)+a₂*x+a₃*y+ . . . a_{q}*f_{q}(x,y) for wavelengths kε{kᵣ}

B_{n,k}=B_{{kr}}(x,y,k)=b₁(k)+b₂*x+b₃*y+ . . . bₛ*fₛ(x,y) for wavelengths kε{kᵣ}

φ_{n,k}=φ_{{kr}}(x,y,k)=c₁(k)+c₂*x+c₃*y+ . . . c_{f}*f_{f}(x,y) for wavelengths kε{kᵣ}

Furthermore, any fixed colour offset between positions measured at different colours is taken out by applying standard process corrections, known to the person skilled in the art.

With all the approximations which have been performed the number of input equations now has become:

2*kᵣ₀*n0 equations

and the number of parameters now has become:

$$\begin{matrix}n 0 \{ from Pos \} + ( m + {k}_{r 0} - 1 ) \{ from D \} + ( s + {k}_{r 0} - 1 ) & \{ from B \} \\ + ( f + {k}_{r 0} - 1 ) \{ from ϕ \} + ( q + {k}_{r 0} - 1 ) & \{ from A \}\end{matrix}$$

A typical example is n0=100, kr0=2 and m, s, f and q are all 10. This results in 400 equations and 141 variables. This provides a typical situation for high speed alignment in which case all fields will be aligned and the number of alignment marks is 100 or more.

It should be noted that the number of assumptions used in determining the minimum number of marks is high. On top of that the variation of the parameters over a wafer is relatively low. Hence, in an embodiment, a strongly over-determined system is used to calculate the variables.

In an embodiment, a link between alignment marks in the X- and Y-direction is made for reducing the number of variables further. Mark depth variation as function of wafer location D(x,y) may e.g., be assumed to be the same for X and Y direction. For the other variables (A, B, φ) similar couplings may be employed.

Some marks may have higher order signals (e.g., 2nd and 3rd order) on top of their 1st order response. In embodiments, the model is adapted to incorporate these signals to lead to an improved result.

As a large number of marks is beneficial, a grid align approach may be advantageously employed, wherein a large number of alignment marks is substantially evenly distributed over substantially the whole wafer surface.

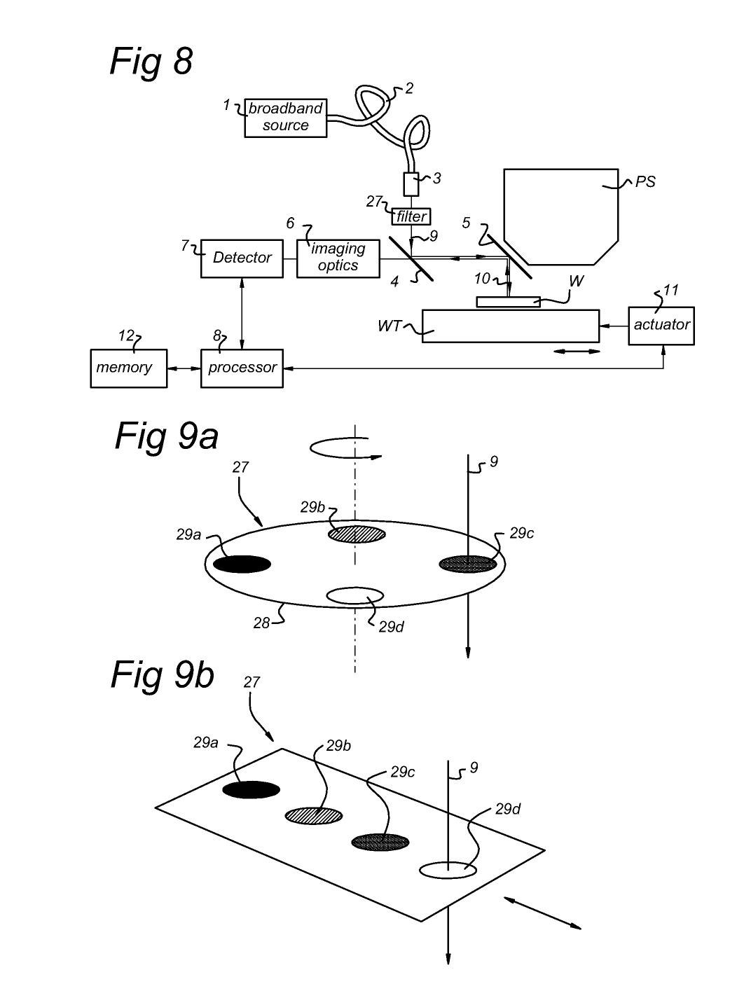

FIG. 8 schematically shows a field image alignment arrangement according to an embodiment of the invention. As compared to the field image alignment arrangement schematically shown in FIG. 2, the field image alignment arrangement of FIG. 9 comprises a filter unit 27. The filter unit 27 is arranged to provide the broadband light beam 9, and thus also broadband alignment beam 10, with a different predetermined selected range of wavelengths before impinging on the mark (not shown) on the substrate W. Note that the filter unit 27 may also be positioned at other positions in an optical pathway of the broadband light beam 9 between the broadband source 1 and the detector 7.

FIGS. 9a and 9b schematically show two examples of filter units that can be used in the alignment arrangement of FIG. 8. In FIG. 9a, a first example of a filter unit 27 is shown. This filter unit 27 comprises a rotatable wheel 28 with a number of filters 29a-d. The filters are used in an embodiment of the invention to enable action 21 of FIG. 7, as explained before. Each filter 29a-d absorbs a different portion of the range of wavelengths in the broadband light beam 9. Consequently, the broadband light beam, is provided with a different predetermined selected range of wavelengths.

FIG. 9b schematically shows a second example of a filter unit 27. Again the filter unit 27 comprises a number of filters 29a-d. However, in this case the filters are not arranged on a rotatable wheel 28, but on a strip 30 that can be moved in a one-dimensional direction substantially perpendicular to the direction of the broadband light beam 9 in FIG. 8. It will be evident to skilled persons in the art that filters 29a-d may also be arranged on other types of carriers. Moreover, in FIGS. 9a, 9b, four filters 29a-d are shown. It will be evident to skilled persons in the art that the number of filters may be unequal to four.

The filter unit 27 may be controlled manually or automatically with a processor. This processor is not necessarily processor 8 but may be so.

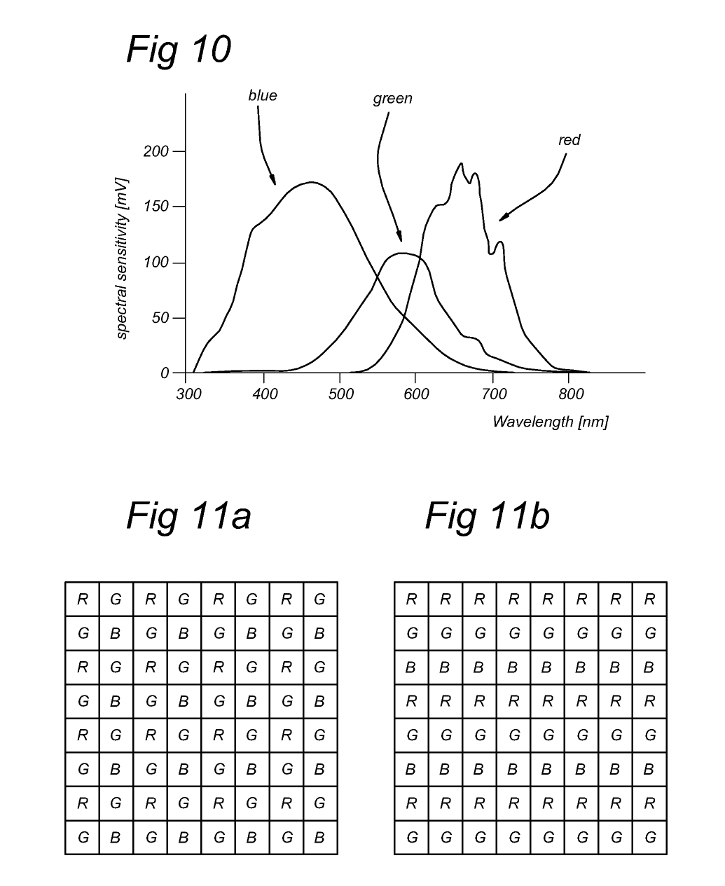

Instead of a filter unit 27, filters may be applied in detector 7. FIG. 10 shows a graph that provides information regarding spectral sensitivity of a multicolor CCD-camera used as detector 7. A CCD is provided with CCD-elements (also referred to ca camera pixels) arranged in columns and rows, thus forming a detecting surface. The size of each element is in the order of a few microns. A multicolor CCD employs so-called filters to give individual elements a sensitivity to a predetermined range of wavelengths, i.e., the elements are (partly) sensitive to “blue”, “green” and “red”. Note that, as can be seen in the graph, the sensitivity of a multicolor CCD-element is not limited to one or two wavelengths but covers a range of wavelengths. Thus, a sensitivity to “red” means that the CCD-element is sensitive for a range of wavelengths in a reddish part of a visual light spectrum. The same accounts for a sensitivity to “blue” and “green”. By detecting an image of a mark that has been illuminated with an alignment beam having a plurality of ranges of wavelengths with a multicolor CCD, e.g., three images of the mark can be obtained in parallel.

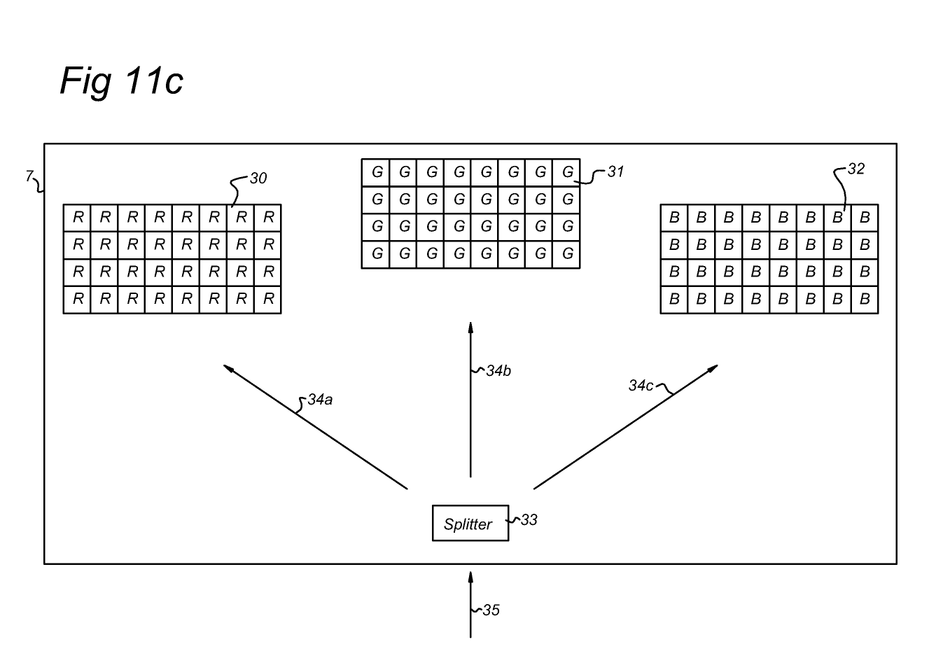

Two examples of filters that can be employed in a multicolor CCD are shown in FIGS. 11a, 11b. In FIG. 11a, the detecting surface is covered with a so-called Bayer-filter. In the shown embodiment, the Bayer filter has twice as many CCD-elements that are sensitive to “green” than CCD-elements that are sensitive to “blue” or “red” as this embodiment is widely used in CCD-cameras. It must be understood that it is also possible to provide a similar arrangement with twice as many “blue” CCD-elements than “green” or “red” CCD-elements, and an arrangement with twice as many “red” CCD-elements than “green” or “blue” CCD-elements. In FIG. 11b, the filter forms lines of CCD-elements that are sensitive to the same color. Note that many other arrangements are possible.

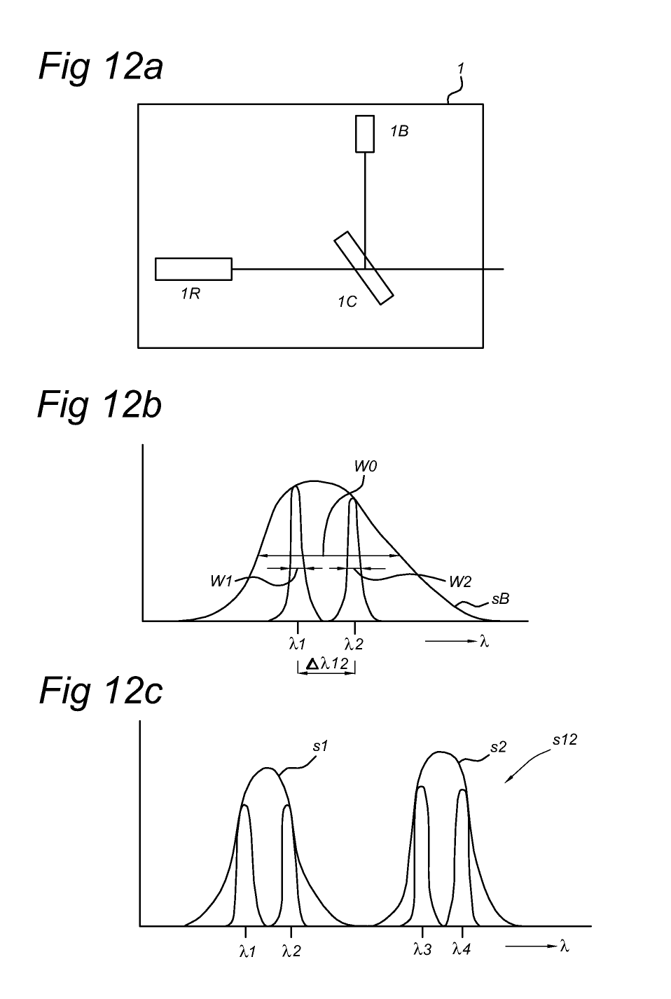

Instead of using a multicolor CCD, it is also possible to use a CCD as a detector 7 that comprises more than one monochromatic detecting surface 30, 31, 32, as schematically shown in FIG. 11c. Alignment radiation 35 coming from the imaging optics 6 is split by a splitter 33 in at least two alignment radiation beams 34. In FIG. 12, the splitter 33 splits the alignment radiation in three alignment radiation beams 34a-c. Each alignment radiation beam 34a-c carries light with a different range of wavelengths. Each alignment radiation beam 34a-c may be detected with an associated detecting surface 30-32. Detecting surface 30 detects the image of the alignment mark that is formed with the range of wavelengths that is carried by alignment radiation beam 34a. Similarly, alignment radiation beam 34b forms an image of the alignment mark on detecting surface 31, and alignment radiation beam 34c forms an image of the alignment mark on detecting surface 32. In FIG. 11c, detecting surface 30 is sensitive to “red”, detecting surface 31 is sensitive to “green” and detecting surface 32 is sensitive to “blue”, in which the sensitivity to a certain “color” has the same meaning as explained before.

In an embodiment, at least two wavelength ranges of the plurality of wavelength ranges have a width in between 2 and 100 nm. In a further embodiment, the width is between 2 and 30 nm. FIG. 12a shows an example of a broad band source 1 used in an field image alignment arrangement according to such embodiment of the invention. As compared to the field image alignment arrangement schematically shown in FIG. 2, the broad band source 1 of the field image alignment arrangement of FIG. 12a comprises a first source 1R and a second source 1B.

The first and second sources may e.g., be narrow band sources generating radiation within a range of at most 30 nm. In an example, the first 1R is a red laser source arranged to provide the broadband light beam 9, and thus also broadband alignment beam 10, with a predetermined selected range of wavelengths in the red, and the second narrow band source 1B is a blue laser source arranged to provide the broadband light beam 9, and thus also broadband alignment beam 10, with a predetermined selected range of wavelengths in the blue.

The first and second sources may e.g., be alternatively be wide-band sources generating radiation within a range of 30-100 nm. In an example, the first 1R is a red Super-Luminescent Diode arranged to provide the broadband light beam 9, and thus also broadband alignment beam 10, with a predetermined selected range of wavelengths in the red, and the second narrow band source 1B is a blue Super-Luminescent Diode arranged to provide the broadband light beam 9, and thus also broadband alignment beam 10, with a predetermined selected range of wavelengths in the blue.

FIG. 12b schematically show an exemplary plurality of wavelength ranges that can be used in the alignment arrangement according to the invention. FIG. 12b shows a spectrum SB of a broadband light beam as generated by a first exemplary broadband source 1. The spectrum SB is a continuous spectrum with a width indicated by w0. The radiation with spectrum SB is filtered by the filter 27 to provide radiation with two narrow-band wavelength ranges shown as a first wavelength range centered around a first center wavelength λ1 having a width w1 and a second wavelength range centered around a second center wavelength λ2 having a width w2. The first and the second wavelength ranges are spaced apart by a center wavelength separation shown as Δλ12.

In an embodiment, the broadband source 1 includes a broad-spectrum laser arranged to provide a broadband light beam, and thus also broadband alignment beam 10, with a plurality of predetermined ranges of wavelengths, spanning a total spectral width of at least 200 nm. The broad-spectrum laser may e.g., be a white laser.

In an embodiment, the broadband source 1 includes a Super-Luminescent Diode (SLD) arranged to provide the broadband light beam 9, and thus also broadband alignment beam 10, with a plurality of predetermined ranges of wavelengths, spanning a total spectral width of at least 100 nm. The SLD may e.g., be a red SLD providing red radiation in the range of 600 to 680 nm. The filter unit 27 may e.g., arranged to select a first narrow wavelength range and a second narrow wavelength range, both narrow wavelength ranges having a width below 50 nm, or even below 20 nm. When using the red SLD, the filter unit 27 may e.g., arranged to select a first narrow wavelength range of e.g., 620 to 640 nm and a second narrow wavelength range of 650 to 680 nm.

FIG. 12c schematically show an exemplary plurality of wavelength ranges that can be used in the alignment arrangement according to the invention. FIG. 12c shows a spectrum S12 of a broadband light beam as generated by an exemplary broadband source 1 comprising two sources, e.g., as shown in FIG. 12a, providing radiation with a first spectrum s1 and a second spectrum s2. The spectrum S12 is thus a non-continuous spectrum with two peaks. The radiation with spectrum S12 is filtered by the filter 27 to provide radiation with two narrow-band wavelength ranges within the first spectrum s1, shown as a first wavelength range centered around a first center wavelength λ1 a second wavelength range centered around a second center wavelength λ2, as well as two narrow-band wavelength ranges within the second spectrum s3, shown as a third wavelength range centered around a third center wavelength λ3 and a fourth wavelength range centered around a fourth center wavelength λ3. The separation between the first and the second wavelength ranges may be referred to as Δλ12. The separation between the third and the fourth wavelength ranges may be referred to as Δλ34.

In an embodiment, the broadband source 1 includes multiple SLDs, e.g., a red SLD and a green SLD arranged to provide the broadband light beam 9, and thus also broadband alignment beam 10, with a plurality of predetermined ranges of wavelengths, wherein the red SLD is arranged to provide a first plurality of predetermined ranges of red wavelengths spanning a first spectral width and the green SLD is arranged to provide a second plurality of predetermined ranges of green wavelengths spanning a second spectral width. The filter unit 27 may then be arranged to select two narrow wavelength ranges from the first plurality of predetermined ranges of red wavelengths, as well as two narrow wavelength ranges from the second plurality of predetermined ranges of green wavelengths. This results in alignment signals corresponding to a first narrow range of red wavelengths, a second narrow range of red wavelengths, a third narrow range of green wavelengths and a fourth narrow range of green wavelengths. The processor 8 may then be configured to select e.g., either the two narrow ranges of red wavelengths, or the two narrow ranges of green wavelengths, or all four narrow ranges of red and green wavelengths. The two narrow ranges of red wavelengths may be closely separated from each other, but relatively largely separated from the two narrow ranges of green wavelengths, which may also be closely separated from each other. In this context, closely separated ranges may correspond to non-overlapping ranges, or to ranges which show some overlap but with different center values.

Closely separated, non-overlapping ranges may in particular correspond to embodiments wherein the least two wavelength ranges of the plurality of wavelength ranges are spaced apart by at most 30 nm in between adjacent wavelength ranges.

In embodiments, the radiation having a plurality of wavelength ranges may thus be generated by a plurality of sources, each source arranged to generate radiation with at least two wavelength ranges of the plurality of wavelength ranges, the at least two wavelength ranges generated by a single source having a width of at 2-100 nm and being separated by at most 50 nm, and the at least two wavelength ranges generated by a single source being separated by at least 50 nm from the at least two wavelength ranges generated by any other sources

In an embodiment, the plurality of wavelength ranges corresponds to at least two wavelengths ranges selected from a blue-violet wavelength range, a red wavelength range, a green wavelength range, a near infra-red wavelength range and a far infra-red wavelength range. In this context, a blue-violet wavelength range is a range within a wavelength of 385 to 450 nm, a green wavelength range is a range within a wavelength of 450 to 590 nm, a red wavelength range is a range within a wavelength of 590 to 680 nm, a near infra-red wavelength range is a range within a wavelength of 680 to 800 nm and a far infra-red wavelength range is a range within a wavelength of 800 to 1500 nm. It will be appreciated that the plurality of wavelength ranges may also correspond to other wavelengths ranges than the ranges given explicitly above.

It should be understood that a processor 8 as used throughout this text can be implemented in a computer assembly 40 as shown in FIG. 13. The memory 12 connected to processor 8 may comprise a number of memory components like a hard disk 41, Read Only Memory (ROM) 42, Electrically Erasable Programmable Read Only Memory (EEPROM) 43 en Random Access Memory (RAM) 44. Not all aforementioned memory components need to be present. Furthermore, it is not essential that aforementioned memory components are physically in close proximity to the processor 8 or to each other. They may be located at a distance away

The processor 8 may also be connected to some kind of user interface, for instance a keyboard 45 or a mouse 46. A touch screen, track ball, speech converter or other interfaces that are known to persons skilled in the art may also be used.

The processor 8 may be connected to a reading unit 47, which is arranged to read data from and under some circumstances store data on a data carrier, like a floppy disc 48 or a CDROM 49. Also DVD's or other data carriers known to persons skilled in the art may be used.

The processor 8 may also be connected to a printer 50 to print out output data on paper as well as to a display 51, for instance a monitor or LCD (Liquid Crystal Display), of any other type of display known to a person skilled in the art.

The processor 8 may be connected to a communications network 52, for instance a public switched telephone network (PSTN), a local area network (LAN), a wide area network (WAN) etc. by way of transmitters/receivers 53 responsible for input/output (I/O). The processor 8 may be arranged to communicate with other communication systems via the communications network 52. In an embodiment of the invention external computers (not shown), for instance personal computers of operators, can log into the processor 8 via the communications network 52.

The processor 8 may be implemented as an independent system or as a number of processing units that operate in parallel, wherein each processing unit is arranged to execute sub-tasks of a larger program. The processing units may also be divided in one or more main processing units with several subprocessing units. Some processing units of the processor 8 may even be located a distance away of the other processing units and communicate via communications network 52.

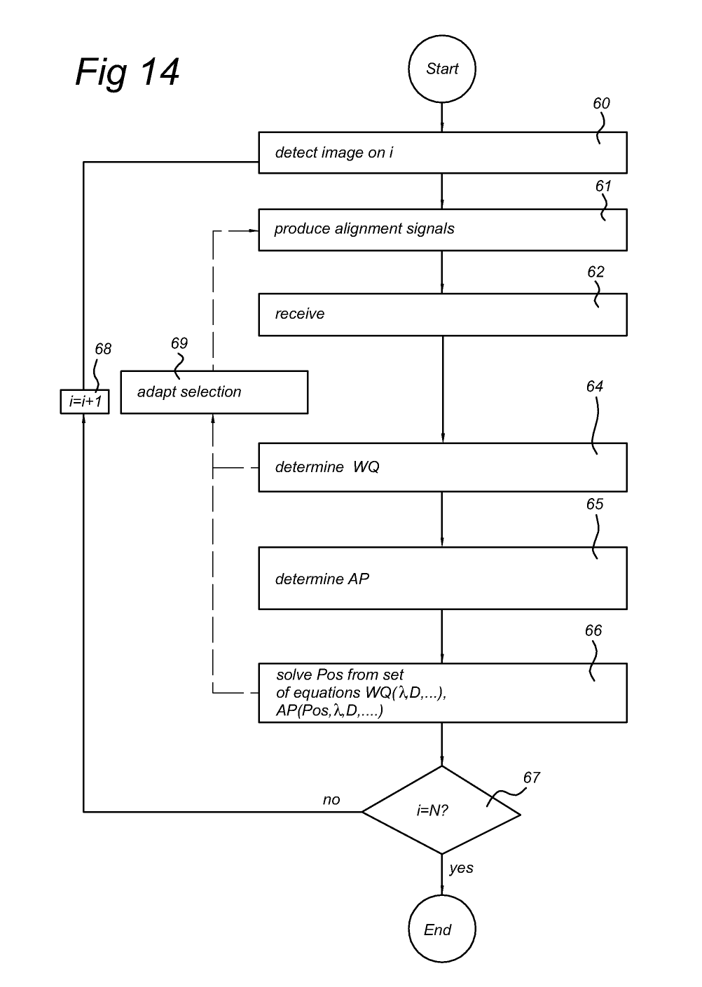

FIG. 14 schematically shows a flow chart according to a second embodiment of the present invention. In this embodiment, not a single substrate but a batch of substrates, i.e., a batch of N substrates, i=1, . . . , N, as shown in FIG. 14, need to be aligned consecutively. Aforementioned embodiment of the method is employed to measure the position of alignment marks on the individual substrates within the batch of substrates. All substrates i are thus aligned by measuring on at least one alignment mark per substrate i.

With respect to the first out of N substrates, i.e., i=1, the alignment measurement method corresponds to the method shown in and explained with reference to FIG. 7. Thus first, in action 60, an image of an alignment mark on the first substrate, i.e., i=1, is detected with light with a plurality of predetermined ranges of wavelengths by a detector 7. Consecutively, in action 61, for each selected range of wavelengths out of said plurality of predetermined ranges of wavelengths, alignment signals are produced with respect to the detected image with that selected range of wavelengths. All produced alignment signals are received by a processor in action 62. Consecutively, the method continues with action 64, in which signal qualities WQ of each of the received alignment signals is determined by using a signal quality indication parameter. Examples of such quality indicating parameters include signal strength, noise level and fit quality of the alignment signal. The signal quality of the alignment signals can automatically be determined by processor 8, as will be evident to persons skilled in the art. Each alignment signal is then used to establish a so-called aligned position AP in action 65. The aligned position corresponds to the position where the alignment signal satisfies a pre-determined condition, as discussed above with reference to FIG. 4. The aligned position may e.g., correspond to the position where the alignment signal shows a maximum. Finally, a position Pos of the at least one alignment mark is determined in action 66, based on the signal qualities WQ and the aligned positions AP for each of the selected range of wavelengths, and equations associated with the modeled relationships between wavelength range and mark characteristics, especially mark depth D and mark asymmetry A, and—in further embodiments—also e.g., a local phase φ and/or a local absorption B. Action 66 e.g., uses the sets of equations described with Example 1 and Example 2 above.

If there is only one substrate to be aligned aforementioned sequence would have come to an end, however, since there are N substrates to be aligned, after alignment of the first substrate out of N substrates, and in most cases after consecutive patterning of a pattern on this aligned first substrate, in action 67 it is verified if the last wafer has been aligned or not. Since so far only the first substrate is aligned and N substrates need to be aligned, the verification is negative and the index i is increased by 1 in action 68.

For the next substrate, i.e., i=1+1=2, the alignment measurement method is repeated, thus producing alignment signals by the detector 7 for each selected range of wavelengths and receiving all alignment signals by the processor 8 respectively.

Until the index number of substrates equals N, actions 68, 60, 61, 62, 64, 65 and 66 are repeated. Hence, the position may be determined for each substrate independently, thus allowing to take differences between marks on different substrates into account. This is advantageous over the method described in U.S. Pat. No. 7,414,722 B2, where, for each of the substrates, the signal qualities as determined with respect to the alignment signals corresponding to the first substrate, are used for selecting or weighing the alignment signals corresponding to different ranges of wavelengths, thus largely ignoring differences between different substrates.

Aforementioned alignment measurement method can be further enhanced in case for one or more of the alignment signals, the signal quality WQ is below a threshold, making the corresponding alignment signal unusable. In that case, after establishing an aligned position AP in action 65, the processor, besides calculating the position of the alignment mark on substrate i in action 66, sends a feedback signal towards the detector 7 so the detector can adapt in action 69 the selection of predetermined ranges of wavelengths it should produce an alignment signal for in action 61. To emphasize that this embodiment is an enhancement, the arrows in the flow diagram of FIG. 14 related to this matter are dashed. Alternatively, after establishing signal quality WQ in action 64, the processor may send a feedback signal towards the detector 7 so the detector can adapt in action 69 the selection of predetermined ranges of wavelengths it should produce an alignment signal for in action 61.

The adaptation is based on the effectiveness of using the alignment signals in determining the position of the mark from there aligned position AP and the signal quality WQ. Thus, if an alignment signal corresponding to a certain predetermined range of wavelength is effectively not used, the adaptation in action 69 will cause the detector 7 to no longer produce that alignment signal.

It should be understood that in case a filter unit 27 is used, as shown in FIGS. 9a, 9b, such a feedback signal to adapt the selection of different predetermined ranges of wavelengths could also be sent to the control unit (not shown) of the filter unit 27. Consequently, the control unit of the filter unit 27 will no longer apply the filters 29a-d, of which the corresponding alignment signals, produced in action 61, are not used in the establishing of the aligned position in action 66, on alignment marks on further substrates i to be measured.

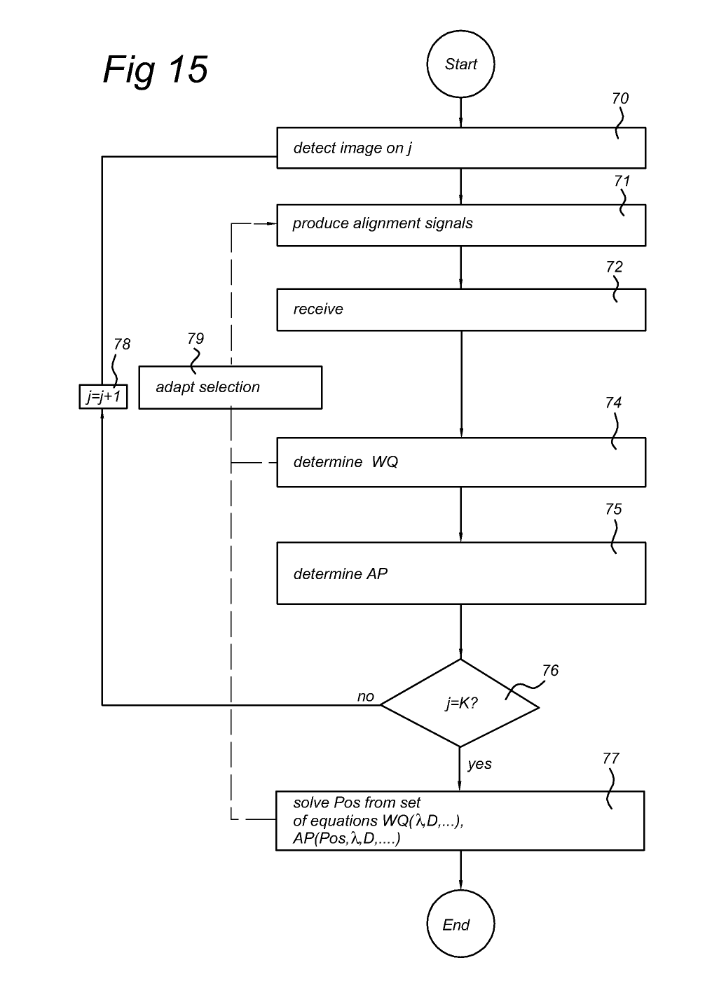

FIG. 15 shows a flow chart of an alignment measurement method according to a third embodiment of the invention. In this embodiment, a similar flow chart as depicted in FIG. 14 is used, however, the method is employed on a number of marks j (j=1, . . . , M) instead of a number of substrates. In this embodiment, detecting the image of the at least one alignment mark comprises detecting a plurality of parts of the images, each of the parts of the image corresponding to a respective alignment mark, and each of the plurality of alignment signals comprises a plurality of alignment signal components associated with the corresponding plurality of parts of the image as detected with the corresponding wavelength range. In the following, a part of an image corresponding to a j-th alignment mark of the at least one alignment mark will be referred to as an image of the j-th alignment mark, and the associated alignment signal components will be referred to as the associated alignment signals, to allow easy reference between FIG. 14 and FIG. 15.

With respect to the first out of K marks, i.e., j=1, the alignment measurement method corresponds to the method shown in and explained with reference to FIG. 7b. Thus first, in action 70, an image of the first alignment mark, i.e., j=1, is detected with light with a plurality of predetermined ranges of wavelengths by a detector 7. Consecutively, in action 71, for each selected range of wavelengths out of said plurality of predetermined ranges of wavelengths, alignment signals are produced with respect to the detected image with that selected range of wavelengths. All produced alignment signals are received by a processor in action 72. Consecutively, the method continues with action 74, in which the signal quality WQ of all received alignment signals is determined by using a signal quality indication parameter. Examples of such quality indicating parameters include signal strength, noise level and fit quality of the alignment signal. The signal quality of the alignment signals can automatically be determined by processor 8, as will be evident to persons skilled in the art. Each alignment signal is then used to establish the so-called aligned position AP in action 75, similar to action 65 in FIG. 14.

If there was only one mark to be measured upon, aforementioned sequence would have come to an end, however, since there are K marks to be measured, after measurement of the first mark out of K marks, it is verified, in action 77, whether the last mark has been measured or not, i.e., whether j=K. In the case that only the first mark is measured, as is the case so far, and K marks need to be aligned, the verification is negative and the index j is increased by 1 in action 78.

For the next alignment mark, i.e., j=1+1=2, the alignment measurement method again starts with action 70, i.e., an image of a next alignment mark, i.e., the second alignment mark, is detected with light with a plurality of predetermined ranges of wavelengths. Consecutively, actions 71 and 72, i.e., producing alignment signals by the detector 7 for each selected range of wavelengths and receiving all alignment signals by the processor 8 respectively, are also performed as described before. Consequently, action 74, in which the signal quality WQ of all received alignment signals is determined by using a signal quality indication parameter.

Until the index number of marks equals K, actions 78, 70, 71, 72, 74 and 75 are repeated.

Finally, a position of each of the alignment marks j=1 . . . K is determined in action 76, based on signal qualities WQ and the aligned positions AP for all alignment marks and for each of the selected range of wavelengths, and the equations associated modeled relationships between wavelength range and mark characteristics, especially mark depth D and mark asymmetry A, and—in further embodiments—also e.g., a local phase φ and/or a local absorption B.

Hence, the position may be determined for each alignment mark on the substrate, thus allowing to take differences between marks on different locations on the substrate into account. This is advantageous over the method described in U.S. Pat. No. 7,414,722 B2, where for all alignment marks the signal quality as determined with respect to the alignment signals corresponding to the first alignment mark were used to select and/or weigh the alignment signals corresponding to different ranges of wavelengths, i.e., largely ignoring differences between different alignment marks. The known method may thus have the risk of using alignment signals with a poor quality when one or more of the alignment marks has become substantially different from the first alignment mark, e.g., having a substantially different mark depth or mark asymmetry due to local differences caused by polishing or etching.

Aforementioned alignment measurement method can be further enhanced in case for one or more of the alignment signals, the signal quality WQ is below a threshold, making the corresponding alignment signal unusable. In that case, after establishing a signal quality WQ in action 74, the processor sends a feedback signal towards the detector 7 so the detector can adapt in action 79 the selection of predetermined ranges of wavelengths it should produce an alignment signal for in action 71. To emphasize that this embodiment is an enhancement, the arrows in the flow diagram of FIG. 15 related to this matter are dashed. Alternatively, after establishing the mark position in action 77, the processor may send a feedback signal towards the detector 7 so the detector can adapt in action 79 the selection of predetermined ranges of wavelengths it should produce an alignment signal for in action 71, when subsequently using the same method on a plurality of alignment marks on a next substrate.

The adaptation is based on the effectiveness of using the alignment signals in determining the position of the mark from the aligned position AP and the signal quality WQ. Thus, if an alignment signal corresponding to a certain predetermined range of wavelengths is not used to establish a further alignment signal for the first mark, the adaptation in action 79 will cause the detector 7 to no longer produce that alignment signal.

It should be understood that in case a filter unit 27 is used, as shown in FIGS. 9a, 9b, such a feedback signal to adapt the selection of different predetermined ranges of wavelengths could also be sent to the control unit (not shown) of the filter unit 27. Consequently, the control unit of the filter unit 27 will no longer apply the filters 29a-d, of which the corresponding alignment signals, produced in action 61, are not used in the establishing of the further alignment signal in action 65, on further alignment marks j to be measured.

It is noted that in the examples described in U.S. Pat. No. 7,414,722 B2 with reference to its FIG. 14 and FIG. 15, the signal quality of the first alignment mark is used for selecting or weighing the alignment signals corresponding to each of the plurality of alignment marks. The method according to the invention may thus be advantageous over the known method of U.S. Pat. No. 7,414,722 B2, as the known method does not account for the differences in signal quality between marks, but only for the differences in signal quality between the different wavelength ranges. Moreover, by using the relationship between the signal quality, wavelengths and mark parameters, in particular mark depth, as well as the relationship between aligned position, mark position, wavelengths and mark parameters, in particular mark depth and mark asymmetry, for the individual marks, optimal use is made of the information that can be extracted from the alignment signal.

Although specific reference may be made in this text to the use of lithographic apparatus in the manufacture of ICs, it should be understood that the lithographic apparatus described herein may have other applications, such as the manufacture of integrated optical systems, guidance and detection patterns for magnetic domain memories, flat-panel displays, liquid-crystal displays (LCDs), thin-film magnetic heads, etc. The skilled artisan will appreciate that, in the context of such alternative applications, any use of the terms “wafer” or “die” herein may be considered as synonymous with the more general terms “substrate” or “target portion”, respectively. The substrate referred to herein may be processed, before or after exposure, in for example a track (a tool that typically applies a layer of resist to a substrate and develops the exposed resist), a metrology tool and/or an inspection tool. Where applicable, the disclosure herein may be applied to such and other substrate processing tools. Further, the substrate may be processed more than once, for example in order to create a multi-layer IC, so that the term substrate used herein may also refer to a substrate that already contains multiple processed layers.

Although specific reference may have been made above to the use of embodiments of the invention in the context of optical lithography, it will be appreciated that the invention may be used in other applications, for example imprint lithography, and where the context allows, is not limited to optical lithography. In imprint lithography a topography in a patterning device defines the pattern created on a substrate. The topography of the patterning device may be pressed into a layer of resist supplied to the substrate whereupon the resist is cured by applying electromagnetic radiation, heat, pressure or a combination thereof. The patterning device is moved out of the resist leaving a pattern in it after the resist is cured.

The terms “radiation” and “beam” used herein encompass all types of electromagnetic radiation, including ultraviolet (UV) radiation (e.g., having a wavelength of or about 365, 355, 248, 193, 157 or 126 nm) and extreme ultra-violet (EUV) radiation (e.g., having a wavelength in the range of 5-20 nm), as well as particle beams, such as ion beams or electron beams.

The term “lens”, where the context allows, may refer to any one or combination of various types of optical components, including refractive, reflective, magnetic, electromagnetic and electrostatic optical components.

The terms “broadband light” and “broadband illumination” used herein encompass light with multiple ranges of wavelengths, including wavelengths within the visible spectrum as well as in the infrared regions. Furthermore, it must be understood that the multiple ranges of wavelengths may not necessarily join together.

While specific embodiments of the invention have been described above, it will be appreciated that the invention may be practiced otherwise than as described. For example, the invention may take the form of a computer program containing one or more sequences of machine-readable instructions describing a method as disclosed above, or a data storage medium (e.g., semiconductor memory, magnetic or optical disk) having such a computer program stored therein.

Although the arrangement as shown with reference to FIG. 2 shows that actuator 11 moves substrate table WT so as to create a movement of alignment beam 10 across substrate W, it should be understood that alignment beam 10 may be moved by suitable devices, e.g., by a mirror actuated to sweep alignment beam 10 across substrate W. Then, the substrate table WT and thus substrate W would remain on a fixed location. Alternatively, in another embodiment, both the substrate table WT and the alignment beam 10 may be moving while performing the measurement.

The descriptions above are intended to be illustrative, not limiting. Thus, it will be apparent to one skilled in the art that modifications may be made to the invention as described without departing from the scope of the claims set out below. In the claims, any reference signs placed between parentheses shall not be construed as limiting the claim. Throughout this document, the term “and/or” includes any and all combinations of one or more of the associated listed items.

1. An alignment measurement method for use with a lithographic apparatus, comprising:
a) detecting an image of at least one alignment mark located on an object by illuminating the mark with radiation having a plurality of wavelength ranges;
b) producing a plurality of alignment signals, each alignment signal being associated with the detected image and with a corresponding wavelength range of the plurality of wavelength ranges;
c) determining a plurality of signal qualities for respective alignment signals by using at least one signal quality indicating parameter;
d) determining a plurality of aligned positions from respective alignment signals by using at least one mark position indicating parameter;
e) determining a position of said at least one alignment mark based at least on at least two of the plurality of signal qualities and at least two of the plurality of aligned positions, wherein said determining of the position of said at least one alignment mark comprises solving a set of equations comprising a plurality of first equations and a plurality of second equations,
the first equations being associated with a first relationship between at least the signal quality, the wavelength range of the radiation and a mark depth of the at least one alignment mark, and
the second equations being associated with a second relationship between at least the aligned position, the position of said at least one alignment mark, the wavelength range of the radiation and the mark depth of the at least one alignment mark.

2. An alignment measurement method according to claim 1, wherein the second relationship further comprises a mark asymmetry parameter of the at least one alignment mark.

3. An alignment measurement method according to claim 2, wherein the asymmetry parameter is a function of the wavelength of the radiation.

4. An alignment measurement method according to claim 2, wherein the first relationship corresponds to:
WQ(λ)=A(λ)·sin²(2πD/λ+φ)
and/or the second relationship corresponds to:
AP(λ)=Pos+B(λ)·tan(2πD/λ+½*π+φ)
wherein:
λ corresponds to the wavelength of the radiation,
D relates to the depth of the mark,
A(λ) relates to a normalization factor,
B(λ) relates to the mark asymmetry parameter, with B(λ)=0 for a symmetric mark,
WQ is signal quality,
Pos relates to the position of the mark,
AP relates to the aligned position; and
φ is a local phase.

5. An alignment measurement method according to claim 4, wherein at least one of A(λ) and B(λ) is approximated by a respective wavelength-independent factor.

6. An alignment measurement method according to claim 1, wherein the plurality of signal qualities and the plurality of aligned positions used in solving the set of equations correspond to the signal qualities and aligned positions of a pre-selected number of wavelengths ranges, the pre-selected number being smaller than the plurality of wavelength ranges.

7. An alignment measurement method according to claim 6, wherein the plurality of signal qualities and the plurality of aligned positions used in solving the set of equations is selected based on corresponding signal qualities.

8. An alignment measurement method according to claim 1, wherein
a′) detecting the image of the at least one alignment mark comprises detecting a plurality of parts of the image, each of the parts of the image corresponding to a respective alignment mark, and wherein
d′) each of the plurality of alignment signals comprises a plurality of alignment signal components associated with the corresponding plurality of parts of the image as detected with the corresponding wavelength range.

9. An alignment measurement arrangement comprising:
a source arranged to generate a radiation beam with a plurality of wavelength ranges;
an optical system arranged to receive said radiation beam as generated, to produce an alignment beam, to direct said alignment beam to at least one mark located on an object, to receive alignment radiation back from said at least one mark and to transmit said alignment radiation;
a detector arranged to receive said alignment radiation and to detect an image of said at least one alignment mark located on said object and to produce a plurality of alignment signals, each alignment signal associated with a corresponding wavelength range; and
a processor connected to said detector wherein said processor is arranged to perform a method comprising:
determining a plurality of signal qualities for respective alignment signals by using at least one signal quality indicating parameter;
determining a plurality of aligned positions from respective alignment signals by using at least one mark position indicating parameter; and
determining a position of said at least one alignment mark based at least on at least two of the plurality of signal qualities and at least two of the plurality of aligned positions,
wherein said determining of the position of said at least one alignment mark comprises solving a set of equations comprising a plurality of first equations and a plurality of second equations, the first equations being associated with a first relationship between at least the signal quality, the wavelength range of the radiation and a mark depth of the at least one alignment mark, and the second equations being associated with a second relationship between at least the aligned position, the position of said at least one alignment mark, the wavelength range of the radiation and the mark depth of the at least one alignment mark.

10. An alignment measurement arrangement according to claim 9, wherein
the source comprises a superluminescent diode and/or a broadband laser.

11. A lithographic apparatus arranged to transfer a pattern from a patterning device onto a substrate, the lithographic apparatus comprising:
an alignment measurement arrangement according to claim 9, wherein said processor is further arranged to establish a position signal based on the position of said at least one alignment mark as determined;
an actuator connected to said processor being arranged to:
receive said position signal;
calculate a position correction based on said position signal as received;
establish a position correction signal.
a support structure arranged to support said substrate to be aligned, said support structure being connected to said actuator;
wherein said actuator is arranged to move said support structure in response to said position correction signal as established.

12. A device manufacturing method comprising transferring a pattern from a patterning device onto a substrate using the lithographic apparatus as defined by claim 11.

13. A computer program product comprising data and instructions to be loaded by a processor of a lithographic apparatus, and arranged to allow said lithographic apparatus to perform the alignment measurement method as recited in claim 1.

14. A machine readable data carrier comprising a computer program product as claimed in claim 13.

15. A machine readable medium comprising machine executable instructions for performing the alignment measurement method of claim 1.
